(19) United States
(12) Patent Application Publication
(10) Pub. No.: US 2026/0072617 A1
(43) Pub. Date: Mar. 12, 2026

(54) STORAGE SYSTEM

(71) Applicant: Hitachi Vantara, Ltd., Yokohama-shi (JP)

(72) Inventors: Hideyuki KOSEKI, Tokyo (JP); Takahiro YAMAMOTO, Tokyo (JP); Taisuke ONO, Tokyo (JP); Norio SHIMOZONO, Tokyo (JP)

(73) Assignee: Hitachi Vantara, Ltd., Yokohama-shi (JP)

(21) Appl. No.: 19/078,056

(22) Filed: Mar. 12, 2025

(30) Foreign Application Priority Data
Sep. 6, 2024 (JP) 2024-153922

(51) Int. Cl. G06F 3/06

(52) U.S. Cl. CPC G06F 3/0659; G06F 3/0613; G06F 3/0679

(57) ABSTRACT

An object of the present invention is to increase the efficiency of writing of a data assurance code. A storage system includes: a processor; and a memory, and atomic write which assures data before update during update write of data can be executed. In the storage system, the processor determines whether the atomic write is applied or not on the basis of a write parameter of a data assurance code of user data which is to be subjected to update write, and in the case where it is determined that the atomic write is applied, executes update write of the data assurance code using the atomic write, and in the case where it is determined that the atomic write is not applied, writes log data including a copy of the data assurance code and, after that, executes write of the data assurance code.

### CLAIM OF PRIORITY

The present application claims priority from Japanese patent application JP 2024-153922 filed on September 6, 2024, the content of which is hereby incorporated by reference into this application.

### BACKGROUND

This invention relates to a storage system.

As a background art of this disclosure, there is Japanese Unexamined Patent Application Publication No. 2023-40672. Japanese Unexamined Patent Application Publication No. 2023-40672 discloses a storage system in which writing to a storage device in an additional process for solving a write hole problem is suppressed.

The storage system includes a computer, a nonvolatile storage device, and a high-speed storage device which can be accessed at a speed higher than that for the storage device, and a drive log including write log information is recorded in the high-speed storage device. When a write request of write data is received, the computer performs drive log checking process first and, then, performs data writing process. In the drive log checking process, in the case where a duplicate write log record is recorded in a drive log, the computer changes the write log state of the duplicate write log record to “completed” with respect to the drive log and write log information as a target and, after that, proceeds to the data writing process. In the case where a duplicate write log record is not recorded, the computer proceeds to the data writing process without changing the drive log and the write log information (refer to, for example, Abstract).

### SUMMARY

Some of storage systems generate a data assurance code from user data and store the data assurance code in a physical storage area different from the area of the user data. By the data assurance code, reliability can be improved. From the viewpoint of performance improvement of a storage system, it is desired to increase the efficiency of writing of a data assurance code to a physical storage area.

A storage system includes: a processor; and a memory, and atomic write which assures data before update during update write of data can be executed. In the storage system, the processor determines whether the atomic write is applied or not on the basis of a write parameter of a data assurance code of user data which is to be subjected to update write, and in the case where it is determined that the atomic write is applied, executes update write of the data assurance code using the atomic write, and in the case where it is determined that the atomic write is not applied, writes log data including a copy of the data assurance code and, after that, executes write of the data assurance code.

One embodiment of the present invention improves the performance of the storage system.

### BRIEF DESCRIPTION OF THE DRAWINGS

FIG. 1 illustrates a configuration example of a storage system according to a first embodiment.

FIG. 2 illustrates an example of a hardware configuration of a storage node.

FIG. 3 illustrates an example of a logical configuration of the storage node.

FIG. 4 illustrates an example of a data protection in the storage system.

FIG. 5 schematically illustrates a configuration of a storage area of a storage device or a cloud block storage service.

FIG. 6 is a diagram for explaining a write process flow of a log write method.

FIG. 7 is a diagram for explaining a write process flow using an atomic write function.

FIG. 8A is a diagram for explaining selection of an atomic write method.

FIG. 8B is a diagram for explaining selection of the log write method.

FIG. 9 illustrates a configuration example of a volume area management table.

FIG. 10 illustrates a configuration example of a storage device area management table.

FIG. 11 illustrates a configuration example of an atomic write requirement management table.

FIG. 12 illustrates a flowchart example of a write process of the storage system.

FIG. 13 illustrates a flowchart example of a destage process in FIG. 12.

FIG. 14 illustrates a flowchart example of a DIF drive storing process in FIG. 13.

FIG. 15 illustrates a flowchart example of a destage process in a second embodiment.

FIG. 16 illustrates a flowchart example of a DIF drive storing process in a standby node in FIG. 15.

### DETAILED DESCRIPTION

One embodiment of the invention will now be described with reference to the drawings. The present invention will not be interpreted by being limited to the description of the following embodiments. A person skilled in the art will easily understand the concrete configurations can be changed without departing from the idea and the gist of the present invention.

Notations such as “first”, “second”, and “third” in the specification and the like are used only to identify components and do not always refer to the number or order. In the configurations of the invention to be described hereinafter, the same reference numeral is assigned to the same or similar configuration/function, and repetitive description will not be given.

In the following description, in the case where elements of the same kind are not distinguished, a common code in a reference code (or reference code) is used. In the case of distinguishing elements of the same kind, reference codes (or IDs of the elements) may be used.

A program performs a predetermined process by being executed by a processor (for example, a CPU (Central Processing Unit)) included in a storage controller in a storage device while properly using a storage resource (for example, a memory) and/or a communication interface device (for example, a host I/F). Consequently, the subject of the process may be the storage device or the processor. The storage controller may include a hardware circuit performing a part or all of the process. A computer program may be installed from a program source. The program source may be, for example, a program distribution server or a computer-readable storage medium.

### First Embodiment

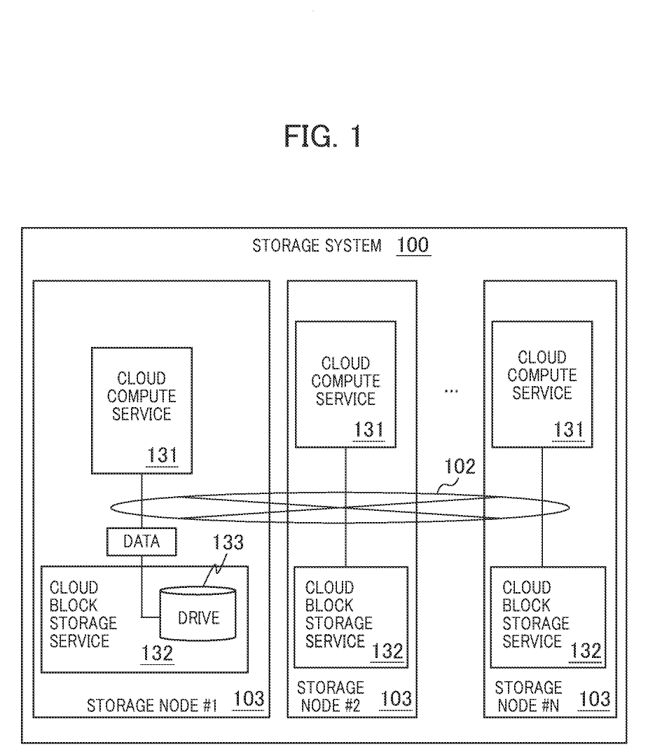

FIG. 1 illustrates a configuration example of a storage system according to a first embodiment. A storage system 100 includes a plurality of storage nodes 103. The storage system 100 is scalable, and the storage node 103 can be added/deleted. The storage system 100 is, for example, an SDS (Software Defined Storage). The storage system 100 may also include a management node. A host device accesses the storage system 100 to write data and read data.

The storage nodes 103 are connected to one another via a network 102 configured by Fibre Channel, Ethernet, LAN (Local Area Network), or the like.

The storage node 103 is a computer device including one or more physical storage devices (also called a storage drive or simply called a drive) 133 and provides a storage area for reading/writing data to the host device. The storage node 103 is, for example, a general-purpose server device.

The storage node 103 executes a cloud compute service 131 and a cloud block storage service 132. The cloud compute service 131 transfers user data between the host device and the cloud block storage service 132. The cloud compute service 131 receives data from the host device, performs a predetermined process on the data, and transfers the data to the cloud block storage service 132. The cloud compute service 131 also performs a predetermined process on data received from the cloud block storage service 132 and transfers the data to the host device.

The cloud block storage service 132 stores various data including user data into one or more physical storage devices 133 and reads the data from the storage devices 133. The cloud block storage service 132 provides one storage area managed by, for example, an LBA (Logical Block Address) and provides so-called an atomic write function as a platform function.

The atomic write function is a function of assuring atomicity of writing of an entire block, that is, assuring that all of data of a block is written or data of a block is not written at all. As described above, the atomic write function assures that the state of data is “before writing” or “after writing” even when a failure during writing (shorn write) occurs. By this function, duplicate writing of data becomes unnecessary, and the performance of the storage system can be improved. The atomic write function can improve performance by making duplicate writing of meta data unnecessary.

As described above, the storage system 100 can include two or more storage nodes 103. The configuration illustrated in the diagram is an example. The host device, the storage node 103, and the management node may be the same node, realized by a virtual machine or a container, or exist together as processes. The number of storage nodes may be one.

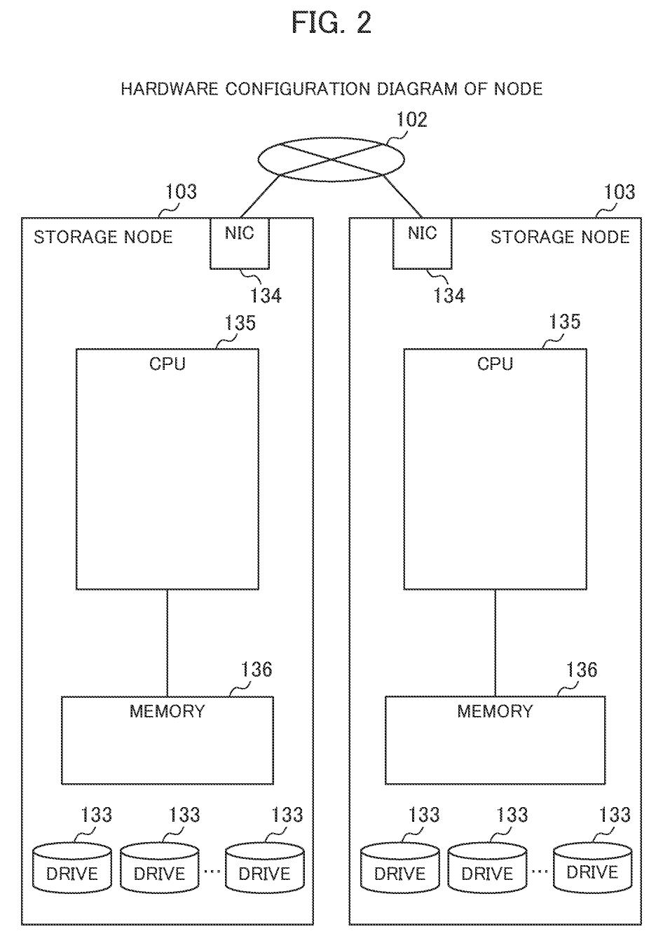

FIG. 2 illustrates an example of a hardware configuration of the storage node 103. The storage node 103 has a CPU 135, a memory 136, a plurality of storage devices (drives) 133, and a communication device 134 (NIC).

The CPU 135 is a processor performing the operation control on the entire storage node. The memory 136 is used to temporarily hold various programs and necessary data. When a program stored in the volatile memory 136 is executed by the CPU 135, various processes of the entire storage node 103 as described later are executed.

The storage device 133 includes one or a plurality of kinds of large-capacity nonvolatile storage devices such as SSDs (Solid State Drives). The storage device 133 provides a physical storage area from/to which data is read/written in accordance with an I/O request from the host device.

The communication device 134 is an interface used by the storage node 103 to perform communication with the host device, another storage node 103, or the management node via the network 102. The communication device 134 is configured by, for example, an NIC, an FC card, or the like. The communication device 134 performs protocol control at the time of communication with the host device, another storage node 103, or the management node.

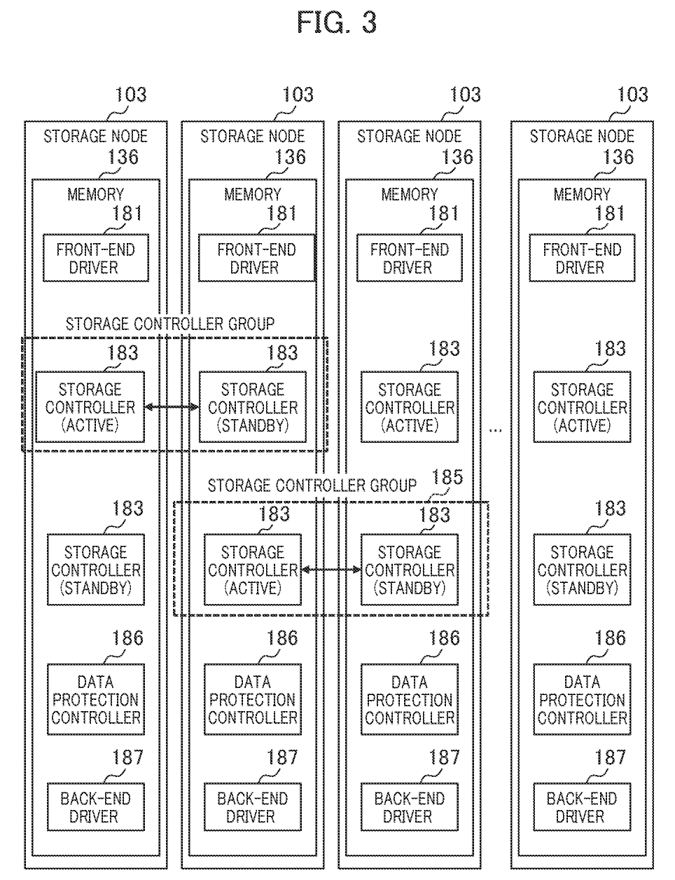

FIG. 3 is a diagram illustrating an example of a logical configuration of the storage node 103. The storage node 103 has the memory 136. The memory 136 stores a plurality of programs which are a front-end driver 181, a back-end driver 187, one or plural storage controllers 183, and a data protection controller 186. FIG. 3 illustrates two storage controllers 183 in each node 103.

The front-end driver 181 is software having the function of controlling the communication device 134 and providing an abstracted interface at the time of communication with the host device, another storage node 103, or the management node to the storage controller 183.

The back-end driver 187 is software having the function of controlling each of the storage devices 133 in its storage node 103, and providing abstracted interface at the time of communication with each of the storage devices 133.

The storage controller 183 is software functioning as a controller of an SDS (Software Defined Storage). The storage controller 183 receives an I/O request from the host device and issues an I/O command according to the I/O request to the data protection controller 186.

The storage controller 183 has a logic volume configuration function. The logic volume configuration function associates a logic chunk constructed by the data protection controller 186 and a logic volume which is provided to the host. For example, a straight mapping method (of mapping a logic chunk and a logic volume on a one-to-one basis (1:1) and making the address of the logic chunk and the address of the logic volume the same) may be employed. Alternatively, a virtual volume function (thin provisioning) method (of separating the logic volume and the logic chunk to small-sized areas (pages) and associating the address of the logic volume and the address of the logic chunk on the page unit basis) may be employed.

Each of the storage controllers 183 mounted in the storage nodes 103 is managed together with another storage controller 183 placed in another storage node 103 as a pair serving as a redundant configuration. Hereinafter, the pair will be called a storage controller group 185.

FIG. 3 illustrates the case where one storage controller group 185 is configured by two storage controllers 183. One redundant configuration may be configured by three or more storage controllers 183. For example, one of the storage controllers may be in an active mode, and another storage controller may be in a standby mode.

In the storage controller group 185, one of the storage controllers 183 is set in a state where it can accept an I/O request from the host device (a state of an actual use system, which will be hereinafter called an active mode). In the storage controller group 185, the other storage controller 183 is set in a state where it does not accept an I/O request from the host device (a state of a standby system, which will be hereinafter called a standby mode). A node in the active mode will be called an active node, and a node in the standby mode will be called a standby node.

In the storage controller group 185, in the case such that a failure occurs in the storage node 103 in which the storage controller 183 set in the active mode (hereinafter, called an active storage controller) is arranged, the state of the storage controller 183 which is set in the standby mode until then (hereinafter, called a standby storage controller) is switched to the active mode.

Consequently, in the case where the active storage controller becomes unable to operate, the I/O process executed by the active storage controller can be taken over by the standby storage controller. To realize this function, the standby storage controller makes a data user cache and control information of the active storage node controller redundant and holds them.

The data protection controller 186 is software having the function of allocating physical storage areas provided by the storage device 133 in its storage node 103 or another storage node 103 to each of the storage controller groups 185, and reading/writing designated data from/to the corresponding storage device 133 in accordance with an I/O command given from the storage controller 183.

When a physical storage area provided by the storage device 133 in another storage node 103 is allocated to the storage controller group 185, the data protection controller 186 transmits/receives data to/from the data protection controller 186 mounted in the another storage node 103 via the network 102 in cooperation with the data protection controller 186, thereby reading/writing the data from/to the storage area in accordance with an I/O command given from the storage controller of the storage controller group 185.

When an I/O command is given, the data protection controller 186 transmits/receives data to/from the data protection controller 186 in another storage node 103, and stores redundant data into the storage system 100. It prevents data loss in the case where the storage node 103 or the storage device 133 in the storage node 103 fails. The data protection controller 186 may realize redundancy by mirroring or may realize redundancy by RAID or erasure coding. The redundancy may be one or greater.

As described above, the storage controller 183 is an upper-layer program, and the data protection controller 186 is a lower-layer program.

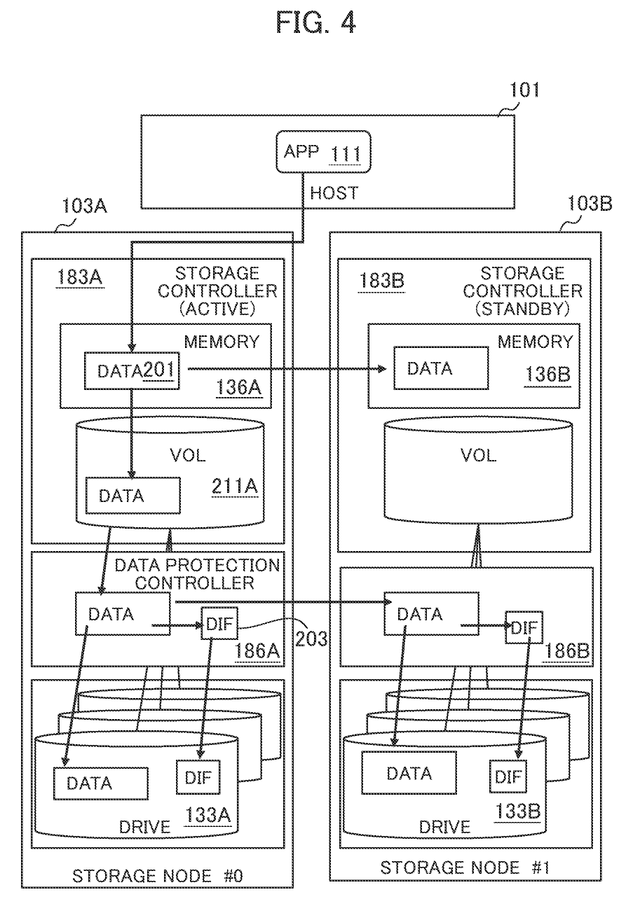

FIG. 4 illustrates an example of data protection in the storage system 100. In the example illustrated in FIG. 4, data protection by mirroring between storage nodes is performed. FIG. 4 illustrates a host device 101 executing an application program 111 and two storage nodes 103A and 103B.

The host device 101 is a general-purpose computer device transmitting a read request or a write request (also called an I/O (Input/Output) request) to the storage node 103 in response to a user operation or a request from the application program 111 or the like mounted. The host device 101 may be a virtual computer device such as a virtual machine.

The node 103A executes a storage controller 183A which is active. The active storage controller 183A provides a logic volume (VOL) 211 to the host device 101. The logic volume is configured by bundling one or plural physical storage devices 133A (cloud storage service). The application program (APP) 111 designates an address to which the logic volume 211 is to be stored and transmits user data (host data) 201 to the storage node 103A.

The user data 201 is cached in a memory 136A and, after that, logically stored in the logic volume 211. The storage controller 183A transfers the user data 201 to a storage controller 183B in a standby state constituting the group (pair). The storage controller 183B cashes the received user data 201 in a memory 136B.

A data protection controller 186A of the node 103A generates a DIF (Data Integrity Field) 203 as a data assurance code from the user data 201. The DIF 203 is stored together with the user data 201 into the physical storage device 133A in the node 103A.

The data protection controller 186A transfers the user data 201 to a data protection controller 186B in the node 103B. The data protection controller 186B generates the DIF 203 from the received user data 201. The DIF 203 is stored together with the user data 201 into a physical storage device 133B in the node 103B. In such a manner, the data protection controllers 186A and 186B mirror (duplicate) the user data 201 between the storage nodes 103A and 103B.

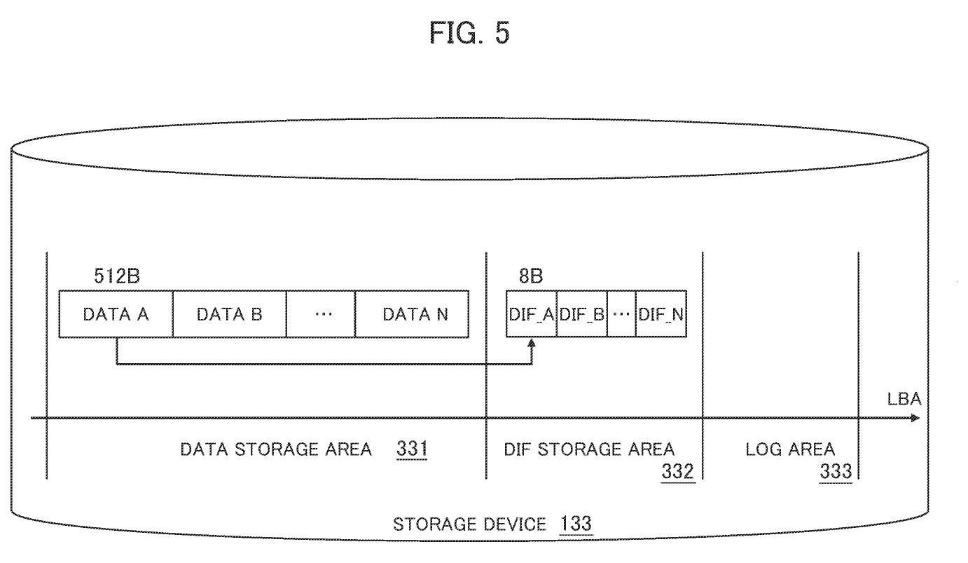

FIG. 5 schematically illustrates the configuration of a storage area of the storage device 133 or the cloud block storage service 132. The storage area of the storage device 133 is managed by addresses (LBA) and includes three partial areas. The partial areas are a data storage area 331, a DIF storage area 332, and a log area 333. The areas are areas of continuous LBAs. The data storage area 331 is an area storing user data. The DIF storage area 332 is an area storing a DIF generated from the user data. The log area 333 is an area utilized at the time of storing the DIF in a drive.

In the example illustrated in FIG. 5, a DIF of 8B is generated for the user data of 512B. The DIF of 8 bytes corresponds to the user data of 512B on a one-on-one basis. The DIF includes information of a CRC and an LBA (Logic Block Address) like T10 DIF. The storage area of the storage device 133 is accessed in the unit of a sector of 512B. Consequently, the user data in the 512B unit and the DIF in the 8B unit are stored in different areas. The sector size of the storage device 133 and the size of the DIF are not limited to the above values.

The storage node 103 according to the embodiment of the specification selectively executes a write process in the log write method and a write process using the atomic write function. Hereinafter, the write processes of the two kinds will be described.

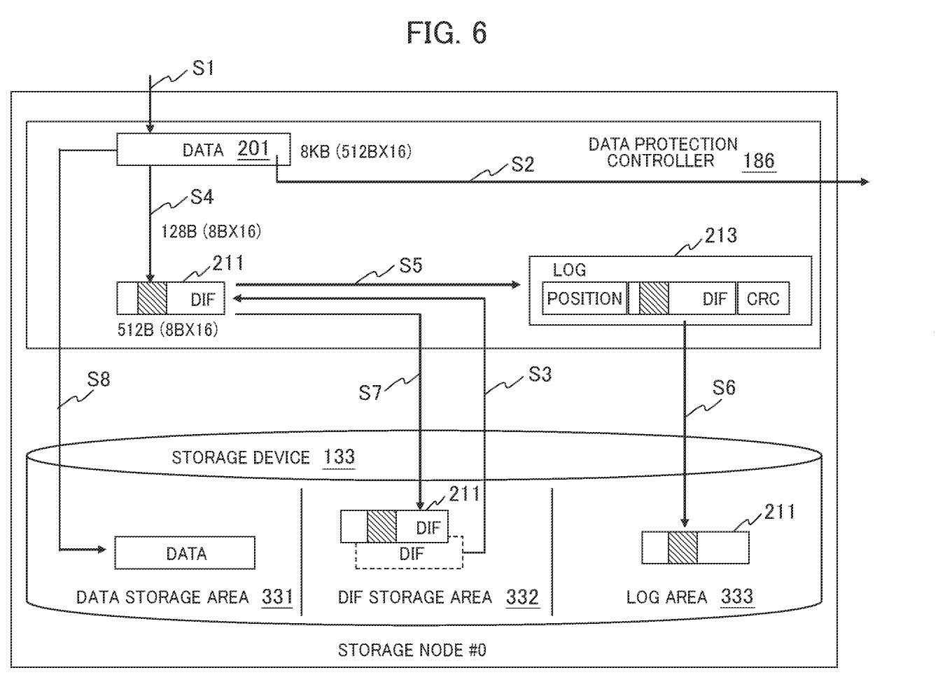

FIG. 6 is a diagram for explaining a write process flow of the log writing method. A case that a write I/O of 8 KB (8192B) is received from the host device 101 is illustrated.

The storage controller 183 receives user data from the host device 101 and caches it in the memory 136. The storage controller 183 requests the data protection controller 186 to perform a process of destaging the data 201 (storage to the storage device 133) (S1).

The data protection controller 186 transmits a mirroring request to the standby node 103 in the same group (S2). Concretely, the data protection controller 186 transmits a destage request together with the data 201.

The data protection controller 186 reads a DIF from the storage device 133 (S3). Since the host write size is 8 KB, the corresponding DIF is 128B. From the storage device 133, data is read on the 512B unit basis. In this example, an update target DIF is 128B, so that the DIF data 211 of 512B including the update target DIF is read from the DIF storage area 332.

The data protection controller 186 generates a DIF from the received data 201, and updates the DIF data 211 of 512B read from the DIF storage area 332 (S4). Further, the data protection controller 186 generates a log 213 of the updated DIF data 211 (S5). The log 213 includes (a copy of) the DIF data 211, information of the storage position of the data, and a CRC. The data protection controller 186 stores the data 211 of 512B of the DIF into the log area 333 (S6).

Subsequently, the data protection controller 186 stores the DIF data 211 into the DIF storage area 332 (S7). Finally, the data protection controller 186 stores the user data 201 into the data storage area 331 (S8).

By the log 213, shorn writing of the DIF can be prevented. As described above, the DIF is updated on the 512B sector unit basis. Consequently, when the size of a DIF to be updated is small, a DIF which is not a writing target is also updated. When a power failure occurs during data writing, the data in the storage device 133 enters a “during write” state (shorn write), and the area which is not the update target may dissipate. Consequently, at the time of performing read-modify-write on a DIF on the 512B unit basis, the DIF is written once in the log area 333 and, after that, the DIF storage area 332 is updated. At the time of a power failure, a broken DIF is recovered from the log.

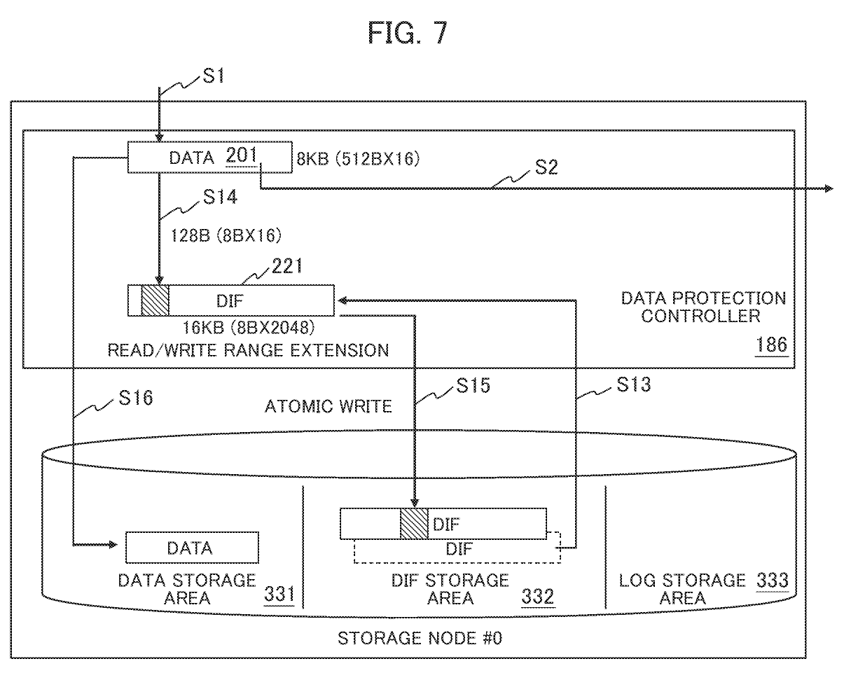

FIG. 7 is a diagram for explaining a write process flow using the atomic write function. There is a requirement to use the atomic write function. Concretely, the size of data which can be atomic written is only a specific value such as, for example, 4 KB, 8 KB, or 16 KB. Further, the start address and the end address of the atomic write update range have to coincide with the address boundaries of the size (4K, 8K, or 16K).

For example, in the case where the update range is 16 KB, the start address and the end address have to coincide with the address boundaries of each 16 KB. The address boundary is fixed in the storage area. The number of usable sizes is one or larger and is arbitrary. For example, each of a plurality of sizes may be integral multiples of the smallest size.

FIG. 7 illustrates the case where a write I/O of 8 KB is received from the host device 101. Steps S1 and S2 are similar to the steps S1 and S2 described with reference to FIG. 6.

Subsequently, the data protection controller 186 reads a DIF from the storage device 133 (S13). In the example, the data protection controller 186 adjusts the size of data to be read so as to match the requirement of the atomic write function. The execution requirements of the atomic write function in this case are that the write data size is 16 KB and the address (LBA) of the write data matches the address boundary of 16 KB.

The data protection controller 186 reads DIF data 221 of a range including an area to be updated and matching the size of 16 KB and the address boundary from the DIF storage area 332 (S13).

The data protection controller 186 generates a DIF from the received data 201 and updates the DIF data 221 read from the DIF storage area 332 (S14). Subsequently, the data protection controller 186 stores the updated DIF data 221 into the DIF storage area 332 (S15). Finally, the data protection controller 186 stores the user data 201 into the data storage area 331 (S16).

In comparison to the log write method described with reference to FIG. 6, the write process using the atomic write extends the size of the DIF data which is subjected to read-modify-write. Concretely, data is extended from 512B to 16 KB. Further, in the write process using the atomic write, generation of a log is unnecessary. Even when a power failure occurs during writing of a DIF, the atomic write function guarantees that the state of data is equal to that before the writing. Consequently, there is no risk of DIF breakage due to shorn write, so that a log can be made unnecessary.

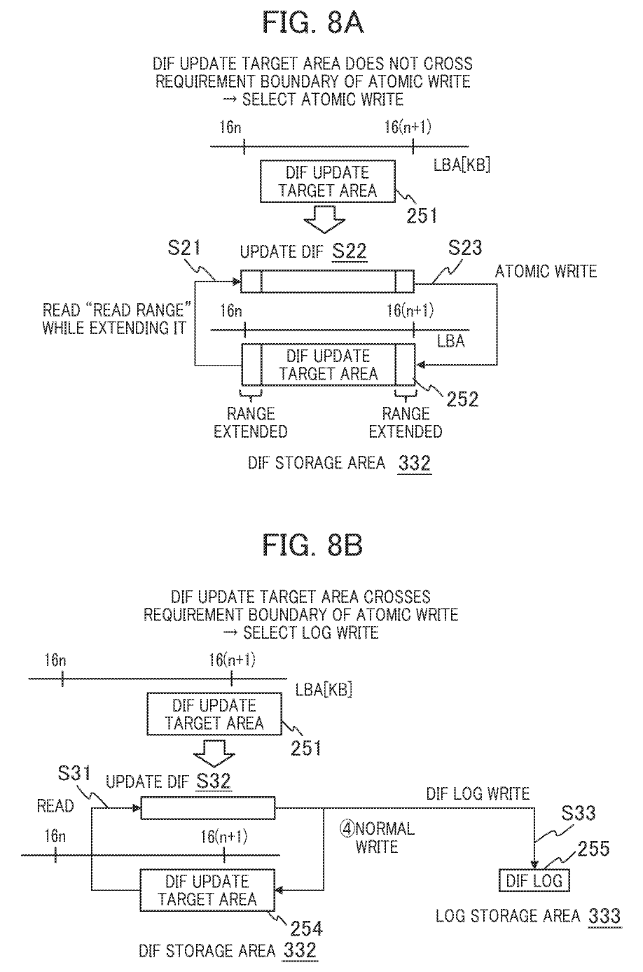

Selection of a write process method from the log write method and the atomic write method will now be described. FIG. 8A is a diagram for explaining selection of the atomic write method, and FIG. 8B is a diagram for explaining the log write method.

The data protection controller 186 calculates the write parameters (write address position (LBA) and a data size) of a DIF from the write parameters (the write address position (LBA) and the data size) of the user data. On the basis of the result, the data protection controller 186 selects one of the atomic write method and the log write method.

As an example, the case that there are limitations of the address boundary of 16 KB and the size in requirements of the atomic write is assumed. When a plurality of sizes such as 4 KB, 8 KB, and 16 KB which can be subjected to the atomic write exist, whether the atomic write can be used or not may be determined by the maximum value of them.

The data protection controller 186 determines whether a DIF update target area 251 crosses the address boundaries of 16 KB (the boundary of the atomic write use requirement) or not. The DIF update target area 251 is DIF data having a size of an integral multiple of 512B, and all or a part of it is actually updated. In FIG. 8A, the DIF update target area 251 does not cross the address boundaries of 16 KB and is included in the area of 16 KB between the adjacent boundaries (the nth and (n+1)th address boundaries). Consequently, the data protection controller 186 selects the atomic write method.

The data protection controller 186 reads DIF data 252 of 16 KB defined by adjacent address boundaries and including the DIF update target area 251 so as to satisfy the requirement of 16 KB size from the DIF storage area 332 (S21). That is, the range to be read is an area obtained by adding a specific range to the DIF update target area 251.

The data protection controller 186 updates a DIF to be updated in the DIF data 252 in the extended range which is read (S22), and writes the entire DIF data 252 in the updated extended range into the DIF storage area 332 by using the atomic write function (S23).

On the other hand, as illustrated in FIG. 8B, in the case where the DIF update target area 251 crosses the address boundary of 16 KB (the boundary of the requirement to use the atomic write), the data protection controller 186 determines that application of the atomic write function is impossible and selects the log write method.

The data protection controller 186 reads the DIF data in the DIF update target area 251 from the DIF storage area 332 (S31). The data protection controller 186 updates the read DIF data (S32), generates a log 255 of the updated DIF data, and writes it in the log area 333 (S33). After that, the data protection controller 186 writes the updated DIF data in the same address area in the DIF storage area 332.

Hereinafter, management information which is retained and used in the storage node 103 will be described. The management information may be stored into the memory 136 and can be stored into the storage device 133 or another nonvolatile storage area.

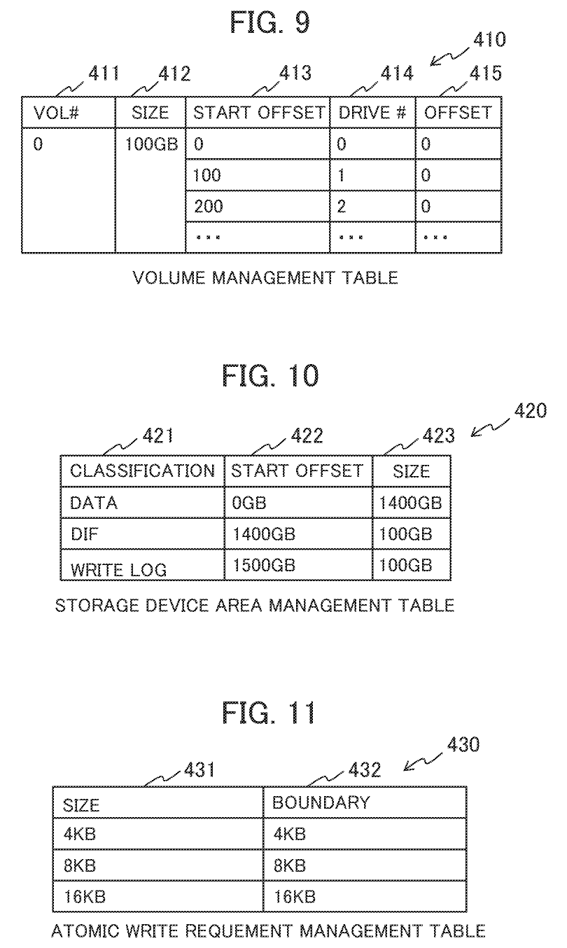

FIG. 9 illustrates a configuration example of a volume management table 410. The volume management table 410 manages information of a logic volume which is provided to the host device 101 by the storage node 103. More concretely, the corresponding relation between a logic storage area in the logic volume and a physical storage area in the storage device is managed.

In the configuration example illustrated in FIG. 9, the volume management table 410 has a volume number field 411, a size field 412, a start offset field 413, a drive number field 414, and an offset field 415.

The volume number field 411 indicates a number identifying a logic volume. The size field 412 indicates the capacity of the logic volume. The start offset field 413 indicates the start address of a storage area in the logic volume. The drive number field 414 and the offset field 415 indicate the number identifying a storage device and the start address of the storage area in the storage device.

FIG. 10 illustrates a configuration example of a storage device area management table 420. The storage device area management table 420 manages the details of the area of the physical storage device. The storage device area management table 420 is retained by each storage device.

In the configuration example illustrated in FIG. 10, the storage device area management table 420 has a classification field 421, a start offset field 422, and a size field 423. The classification field 421 indicates the kind of a storage area, that is, the kind of data stored in the storage area. As described above, the storage area in the storage device includes the data storage area 331, the DIF storage area 332, and the log area 333. The start offset field 422 and the size field 423 indicate the start address position and the size of the storage area, respectively. In FIG. 10, to facilitate illustration, the start offset is expressed by a data amount, not an LBA.

FIG. 11 illustrates a configuration example of an atomic write requirement management table 430. The atomic write requirement management table 430 manages a restriction (use requirement) of the atomic write function. In the configuration example of FIG. 11, the atomic write requirement management table 430 has a size field 431 and a boundary field 432. The size field 431 indicates the data size which allows use of the atomic write function, and the boundary field 432 indicates the position of the address boundary (requirement boundary) which allows use of the atomic write function. The requirement boundary (address) of the atomic write may be, for example, an integral multiple of the value indicated in the boundary field 432. The address of the requirement boundary may not be an integral multiple of the size.

The data protection controller 186 determines whether the atomic write function can be used or not and the adjustment amount (extension range) of the range of access to the storage device 133 with reference to the atomic write requirement management table 430.

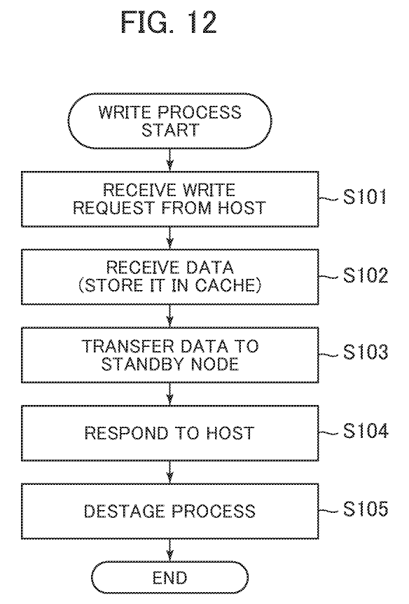

Hereinafter, the processes of the storage nodes 103 will be described with reference to flowcharts. FIG. 12 illustrates a flowchart example of the write process of the storage system 100. A storage node (also called an active node) which executes the active storage controller 183 receives a write request from the host device 101 (S101), and further, receives host data (also simply called data). The active storage controller 183 stores the received data into a cache area in the memory 136 (S102).

The active storage controller 183 transfers host data received and a control parameter indicating the address or the like of the host data to the storage node 103 (called standby node) executing the storage controller 183 (S104). The transferred data is cached in the standby node 103 for redundancy.

Subsequently, the active storage controller 183 returns a write completion response to the host device 101. After that, the active node 103 and the standby node 103 execute destage process (S105).

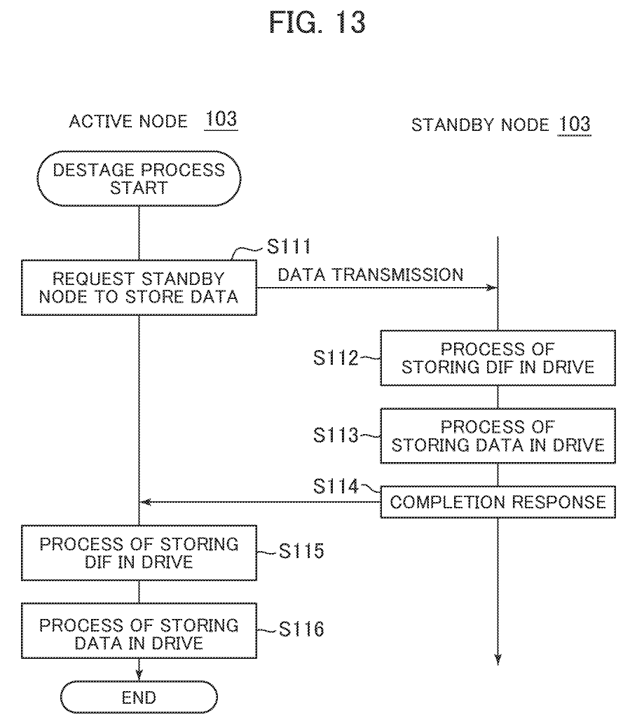

FIG. 13 illustrates a flowchart example of the destage process S105 in FIG. 12. The data protection controller 186 of the active node 103 requests the standby node 103 to store host data received from the host device 101 for duplication (mirroring) (S111). At this time, a destage request is transmitted together with the control information including the parameter indicative of the storage destination and the host data.

The data protection controller 186 of the standby node 103 executes a drive storing process of a DIF (DIF updating process) (S112), and then, executes a drive storing process of the host data (data updating process) (S113). After that, the data protection controller 186 of the standby node 103 returns a request process completion response to the active node 103 (S114).

The data protection controller 186 of the active node 103 which received the completion response executes a drive storing process of a DIF (DIF updating process) (S115), and then, executes a drive storing process (data updating process) of host data (S116).

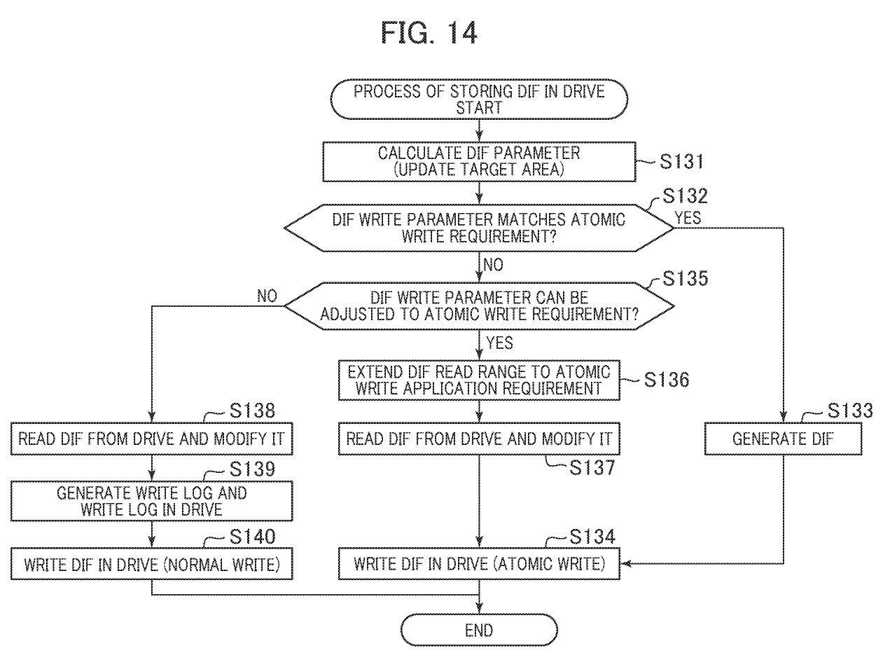

FIG. 14 illustrates a flowchart example of the drive storing processes S112 and S115 of a DIF in FIG. 13. The data protection controller 186 calculates the parameter of the DIF, concretely, the offset (start address) and size of a DIF update target area in the DIF storage area 332 from the host data to be destaged. The relation (and its determining method) between the storage address of host data and the storage address of the DIF is set in advance.

The data protection controller 186 determines whether or not the size and the boundary of the update target area of the DIF match the atomic write requirement (S132). Concretely, the data protection controller 186 refers to the atomic write requirement management table 430 and determines whether or not the size and the boundary of the DIF update target area match the requirement.

In the case of a match (YES in S132), the data protection controller 186 determines that the atomic write is possible, generates a DIF from the host data (S133), and writes the generated DIF into the DIF storage area 332 by using the atomic write. At this time, read-modify is unnecessary.

In the case where the size and the boundary of the update target area do not perfectly match the atomic write requirements (NO in S132), the data protection controller 186 determines whether DIF write parameters (both-end addresses of the write area) can be adjusted to the atomic write requirements (S135). Concretely, as described with reference to FIGS. 8A and 8B, the data protection controller 186 determines whether or not an update target area crosses the boundaries of a maximum size (16 KB in this example) within the boundary restriction of the atomic write requirements (S135).

In the case where the DIF update target area does not cross the boundaries of the maximum size (YES in S135), the data protection controller 186 determines that the atomic write can be used, and extends the DIF read range (S135). In the case where atomic write requirements of a plurality of sizes exist, the smallest size of the read range from a drive is selected.

It is now assumed that atomic write requirements of three sizes of 4 KB, 8 KB, and 16 KB are defined. The data protection controller 186 determines whether or not the DIF update target area cross the boundaries of 8 KB. In the case where the DIF update target area crosses the boundaries of 8 KB, the data protection controller 186 selects a 16 KB access.

In the case where the DIF update target area does not cross the boundaries of 8 KB, the data protection controller 186 determines whether or not the DIF update target area crosses the boundaries of 4 KB. In the case where the DIF update target area crosses the boundaries of 4 KB, the data protection controller 186 selects an 8 KB access. In the case where the DIF update target area does not cross the boundaries of 4 KB, the data protection controller 186 selects a 4 KB access of the DIF update target area.

As described above, by determining whether the DIF update area overlaps the requirement boundary or not in order from the boundary of the largest size, a read-modify area of the smallest size which includes the DIF update target area and is atomic-writable can be selected. Consequently, a data transfer amount can be reduced.

The data protection controller 186 generates a DIF from host data, reads DIF data of the determined size and area from the DIF storage area 332, and updates the DIF data with the generated DIF (S138). After that, the updated DIF data is rewritten into the same address in the DIF storage area 332 (S144).

In the case where the DIF update area crosses the boundaries of 16 KB in step S135 (NO in S135), the data protection controller 186 determines that the atomic write cannot be used, and executes the log write. Concretely, the data protection controller 186 reads DIF data of the size of an integral multiple of 512B (DIF data in the DIF update area) from the DIF storage area 332, and updates the read DIF data with the generated DIF (S138). After that, the data protection controller 186 generates a write log, stores it into the log area 333 (S139), and then, writes the updated DIF data into the DIF storage area 332 (S140). At this time, the atomic write function is not used.

The embodiment uses the atomic write function for updating of a DIF in a manner described above. Consequently, the process load of updating of a DIF can be reduced. By comparing the update target area of a DIF and the atomic write requirement, the DIF updating which can use the atomic write function can be properly determined. In the case where atomic write requirements of a plurality of sizes exist, by selecting the smallest size which can be used, the data transfer amount can be reduced.

In the case where the atomic write is not used, a data write method different from the log write method may be used. Although the use of the atomic write function in writing of a DIF is described in the embodiment, the atomic write function may be used or may not be used in writing of host data.

### Second Embodiment

In the first embodiment, each of the active node 103 and the standby node 103 executes determination of the DIF write method and the DIF generating process. It realizes simple control. In a second embodiment, the active node 103 executes the write method determination and the DIF generating process, and transfers the DIF generating process result to the standby node 103. In addition to the host data, the generated DIF is also transferred from the active node 103 to the standby node 103. The write method determination result may be transmitted or may not be transmitted.

The standby node 103 rewrites the address information of the received DIF data and stores the resultant data in the DIF storage area 332. In such a manner, the process of reading data from the storage device accompanying the DIF generation in the standby node 103 which was performed in the first embodiment can be made unnecessary.

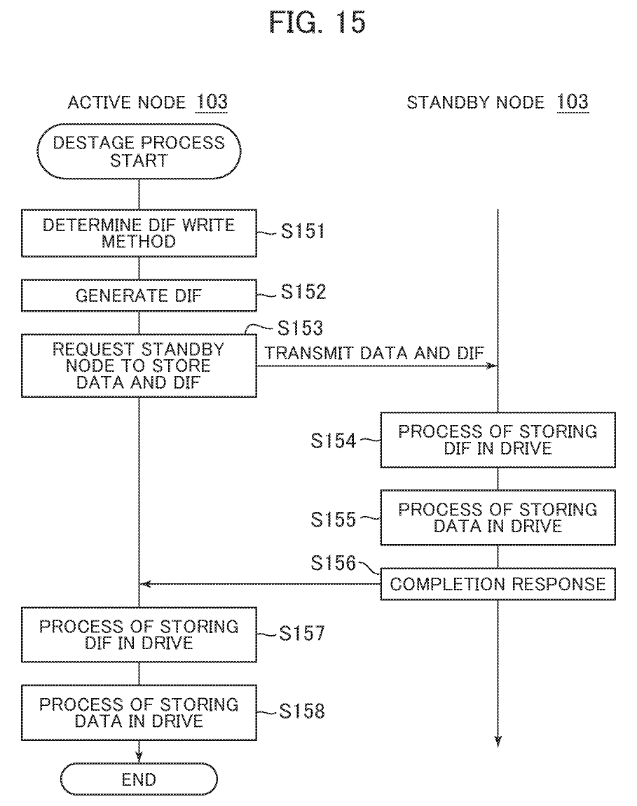

FIG. 15 illustrates a flowchart example of destage process in the second embodiment. In the active node 103, the data protection controller 186 determines a DIF write method (S151) and, further, generates a DIF from host data (S152). For step S151, the description made with reference to steps S131, S132, and S135 in the flowchart of FIG. 14 can be applied. For step S152, the description made with reference to steps S133, S136, S137, and S138 in the flowchart of FIG. 14 can be applied.

Subsequently, the data protection controller 186 of the active node 103 requests the standby node 103 to store the host data and the DIF (S153). At this time, the host data and the DIF data are transmitted. The DIF data transferred is data which can be written as it is into the DIF storage area 332 by the atomic write method or the log write method.

In the standby node 103 which received the request, the data protection controller 186 executes a process of storing a DIF in a drive (S154) and executes a process of storing host data into a drive (S155). After that, the data protection controller 186 sends a completion response to the active node 103 (S156).

In the active node 103 which received the completion response, the data protection controller 186 executes a process of storing a DIF in a drive (S157) and a process of storing host data in a drive (S158). For the step S157, the description made with reference to S134, S139, and S140 can be applied.

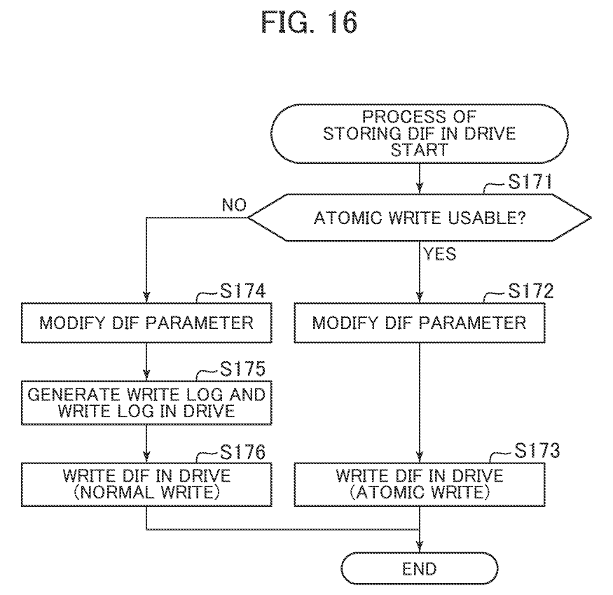

FIG. 16 illustrates a flowchart example of the process of storing a DIF into a drive (S154) in the standby node 103 in FIG. 15. The data protection controller 186 determines whether the atomic write function can be used or not on the basis of the DIF received from the active node 103 (S171). The data protection controller 186 may determine the atomic write requirement in a manner similar to the step S132 in FIG. 14, and the write method may be notified from the active node 103.

In the case where the atomic write can be used for the DIF (YES in S171), the data protection controller 186 rewrites a necessary part in a DIF write parameter (S172), and writes the resultant into the DIF storage area in the drive (S173). In the standby node 103, the storage destination address in the DIF storage area 332 may be changed, so that the address information of the DIF is updated as necessary.

In the case where the atomic write cannot be used for the DIF (NO in S171), the data protection controller 186 writes the DIF into the DIF storage area 332 by the log write method. Concretely, the data protection controller 186 rewrites a necessary part of the address information of the DIF (S174), generates a log, and writes the log into the log area 333 (S175). After that, the data protection controller 186 writes the DIF into the DIF storage area 332 (S176).

In the case where the log write method is selected, the DIF data is not transferred, and the determination result may be transmitted to the standby node 103. The standby node 103 generates a DIF from host data, and executes DIF writing by the log write method described with reference to FIG. 13.

The present invention is not limited to the above-described embodiments, and further includes various modifications. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

A part or all of the above-described configurations, functions, processors, and the like may be realized by hardware by, for example, designing with an integrated circuit. Each of the above-described configurations, functions, and the like may be realized by software by interpreting and executing a program realizing each of the functions by a processor. Information of the programs, tables, files, and the like realizing the functions may be stored in a storage device such as a memory, a hard disk, an SSD or the like or a recording medium such as an IC card, an SD card, or the like.

Control lines and information lines which are considered to be necessary in the description are illustrated. All of control lines and information lines in a product are not always illustrated. It may be considered that almost all of components are connected to one another in reality.

What is claimed is:

1. A storage system comprising:
a processor; and
a memory, wherein
atomic write which assures data before update during update write of data can be executed, and
the processor
determines whether the atomic write is applied or not on the basis of a write parameter of a data assurance code of user data which is to be subjected to update write,
in the case where it is determined that the atomic write is applied, executes update write of the data assurance code using the atomic write, and
in the case where it is determined that the atomic write is not applied, writes log data including a copy of the data assurance code and, after that, executes update write of the data assurance code.

2. The storage system according to claim 1, wherein
the processor
determines a write parameter of the data assurance code, which includes a start position and an end position of an update target area of the data assurance code in a physical storage area on the basis of the write parameter of the user data, and
determines whether or not the atomic write is applied to writing to the update target area on the basis of the start position and the end position.

3. The storage system according to claim 2, wherein
in the case where the start position and the end position of the update target area exist between adjacent address boundaries indicated by a requirement of the atomic write,
the processor extends a reading range from the physical storage area for read-modify-write of the update target area to an area defined by the adjacent address boundaries including the update target area.

4. The storage system according to claim 3, wherein
the requirement of the atomic write indicates an address boundary for each of a plurality of data sizes, and
the processor selects the smallest data size in which writing to the update target area satisfies the requirement of the atomic write, and executes a read-modify-write operation on the update target area.

5. The storage system according to claim 2, wherein
in the case where the update target area crosses an address boundary indicated by the requirement of the atomic write, the processor determines that the writing to the update target area does not satisfy the requirement of the atomic write.

6. The storage system according to claim 2, wherein
the requirement of the atomic write indicates an address boundary for each of a plurality of data sizes, and
in the case where the update target area crosses an address boundary of a maximum size in the plurality of data sizes, the processor determines that writing to the update target area does not satisfy the requirement of the atomic write.

7. The storage system according to claim 1, comprising:
a first storage including the processor and the memory; and
a second storage node, wherein
the second storage node
receives the user data from the first storage node,
determines a start position and an end position of an update target area of a data assurance code in a physical storage area on the basis of a write parameter of the user data,
determines whether or not writing to the update target area can satisfy the requirement of the atomic write on the basis of the start position and the end position, and
in the case where it is determined that writing to the update target area can satisfy the requirement of the atomic write, executes writing to the update target area using the atomic write.

8. The storage system according to claim 1, comprising:
a first storage node including the processor and the memory; and
a second storage node, wherein
the second storage node
receives the user data from the first storage node,
receives data to be written in a physical storage area for updating the data assurance code from the first storage node, and
writes the user data and the data to be written in the physical storage area into different areas in the physical storage area.

9. A method of controlling writing to a physical storage area of a data assurance code in a storage system, comprising the steps of:
determining whether or not atomic write which assures data before update during update write of the data is applied on the basis of a write parameter of the data assurance code of user data which is to be subjected to update write,
in the case where it is determined that the atomic write is applied, executing the update write of the data assurance code using the atomic write and
in the case where it is determined that the atomic write is not applied, writing log data including a copy of the data assurance code and, after that, executing the update write of the data assurance code.
